(19) United States
(12) Patent Application Publication
(10) Pub. No.: US 2024/0080608 A1
(43) Pub. Date: Mar. 7, 2024

(54) PERCEPTUAL ENHANCEMENT FOR BINAURAL AUDIO RECORDING

(71) Applicant: Dolby Laboratories Licensing Corporation, San Francisco, CA (US)

(72) Inventors: Yuanxing MA, Beijing (CN); Zhiwei SHUANG, Beijing (CN); Yang LIU, Beijing (CN)

(73) Assignee: Dolby Laboratories Licensing Corporation, San Francisco, CA (US)

(21) Appl. No.: 18/257,862

(22) PCT Filed: Dec. 14, 2021
(86) PCT No.: PCT/US2021/063203

§ 371 Date: Jun. 15, 2023

Related U.S. Application Data
(60) Provisional application No. 63/139,329, filed on Jan. 20, 2021.
(60) Provisional application No. 63/287,730, filed on Dec. 9, 2021.

(30) Foreign Application Priority Data
Dec. 22, 2020 (WO) PCT/CN2020/138221

(51) Int. Cl. H04R 1/10; H04R 5/04; H04S 7/00

(52) U.S. Cl. CPC H04R 1/1083; H04R 5/04; H04S 7/301; H04R 2430/03; H04R 2499/11; H04S 2400/01; H04S 2400/15; H04S 2420/07

(57) ABSTRACT

A method of audio processing includes capturing a binaural audio signal, calculating noise reduction gains using a machine learning model, and generating a modified binaural audio signal. The method may further including performing various corrections to the audio to account for video captured by different cameras such as a front camera and a rear camera. The method may further include performing smooth switching of the binaural audio when switching between the front camera and the rear camera. In this manner, noise may be reduced in the binaural audio, and the user perception of the combined video and binaural audio may be improved.

### CROSS REFERENCE TO RELATED APPLICATIONS

This application claims priority to U.S. Provisional Application No. 63/139,329, filed 20 Jan. 2020 and U.S. provisional application 63/287,730, filed 9 Dec. 2021 and PCT Application No. PCT/CN2020/138221, filed 22 Dec. 2020, all of which are incorporated herein by reference in their entirety.

### FIELD

The present disclosure relates to audio processing, and in particular, to noise suppression.

### BACKGROUND

Unless otherwise indicated herein, the approaches described in this section are not prior art to the claims in this application and are not admitted to be prior art by inclusion in this section.

Devices for audiovisual capture are becoming more popular with consumers. Such devices include portable cameras such as the Sony Action Cam™ camera and the GoPro™ camera, as well as mobile telephones with integrated camera functionality. Generally, the device captures audio concurrently with capturing the video, for example by using monaural or stereo microphones. Audiovisual content sharing systems, such as the YouTube™ service and the Twitch.tv™ service, are growing in popularity as well. The user then broadcasts the captured audiovisual content concurrently with the capturing or uploads the captured audiovisual content to the content sharing system. Because this content is generated by the users, it is referred to as user generated content (UGC), in contrast to professionally generated content (PGC) that is typically generated by professionals. UGC often differs from PGC in that UGC is created using consumer equipment that may be less expensive and have fewer features than professional equipment. Another difference between UGC and PGC is that UGC is often captured in an uncontrolled environment, such as outdoors, whereas PGC is often captured in a controlled environment, such as a recording studio.

Binaural audio includes audio that is recorded using two microphones located at a user's ear positions. The captured binaural audio results in an immersive listening experience when replayed via headphones. As compared to stereo audio, binaural audio also includes the head shadow of the user's head and ears, resulting in interaural time differences and interaural level differences as the binaural audio is captured.

### SUMMARY

Existing audiovisual capture systems have a number of issues. One issue is that many existing capture devices include only mono or stereo microphones, making the capture of binaural audio especially challenging. Another issue is that UGC audio often has stationary and non-stationary noise that is not present in PGC audio due to the PGC often being captured in a controlled environment. Another issue is that independent audio and video capture devices may result in audio and video streams that are inconsistent with human perception using eyes and ears.

Embodiments relate to capturing video concurrently with binaural audio and performing perceptual enhancement, such as noise reduction, on the captured binaural audio. The resulting binaural audio is then perceived differently from stereo or monaural audio when consumed in combination with the captured video.

According to an embodiment, a computer-implemented method of audio processing includes capturing, by an audio capturing device, an audio signal having at least two channels including a left channel and a right channel. The method further includes calculating, by a machine learning system, a plurality of noise reduction gains for each channel of the at least two channels. The method further includes calculating a plurality of shared noise reduction gains based on the plurality of noise reduction gains for each channel. The method further includes generating a modified audio signal by applying the plurality of shared noise reduction gains to each channel of the at least two channels.

As a result, noise may be reduced in the captured binaural audio.

The machine learning system may use a monaural model, a binaural model, or both a monaural model and a binaural model.

The method may further include capturing, by a video capture device, a video signal contemporaneously with capturing the audio signal. The method may further include switching between a front camera and a rear camera, wherein the switching includes smoothing a left/right correction of the audio signal using a first smoothing parameter, and smoothing a front/back correction of the audio signal using a second smoothing parameter. Capturing the video signal contemporaneously with capturing the audio signal may include performing a correction on the audio signal, where the correction includes at least one of a left/right correction, a front/back correction, and a stereo image width control correction. The stereo image width control correction may include generating a middle channel and a side channel from a left channel and a right channel of the audio signal, attenuating the side channel by a width adjustment factor, and generating a modified audio signal from the middle channel and the side channel having been attenuated.

According to another embodiment, an apparatus includes a processor. The processor is configured to control the apparatus to implement one or more of the methods described herein. The apparatus may additionally include similar details to those of one or more of the methods described herein.

According to another embodiment, a non-transitory computer readable medium stores a computer program that, when executed by a processor, controls an apparatus to execute processing including one or more of the methods described herein.

The following detailed description and accompanying drawings provide a further understanding of the nature and advantages of various implementations.

### BRIEF DESCRIPTION OF THE DRAWINGS

FIG. 1 is a stylized overhead view of an audiovisual capture system 100.

FIG. 2 is a block diagram of an audio processing system 200.

FIG. 3 is a block diagram of an audio processing system 300.

FIG. 4 is a block diagram of an audio processing system 400.

FIG. 5 is a block diagram of an audio processing system 500.

FIG. 6 is a stylized overhead view illustrating binaural audio capture in selfie mode using the video capture system 100 (see FIG. 1).

FIG. 7 is a graph showing an example of the magnitude response of a high-shelf filter implemented using a bi-quad filter.

FIG. 8 is a stylized overhead view showing various audio capture angles in selfie mode.

FIG. 9 is a graph of the attenuation factor α for different focal lengths f.

FIG. 10 is a stylized overhead view illustrating binaural audio capture in normal mode using the video capture system 100 (see FIG. 1).

FIG. 11 is a device architecture 1100 for implementing the features and processes described herein, according to an embodiment.

FIG. 12 is a flowchart of a method 1200 of audio processing.

FIG. 13 is a flowchart of a method 1300 of audio processing.

### DETAILED DESCRIPTION

Described herein are techniques related to audio processing. In the following description, for purposes of explanation, numerous examples and specific details are set forth in order to provide a thorough understanding of the present disclosure. It will be evident, however, to one skilled in the art that the present disclosure as defined by the claims may include some or all of the features in these examples alone or in combination with other features described below, and may further include modifications and equivalents of the features and concepts described herein.

In the following description, various methods, processes and procedures are detailed. Although particular steps may be described in a certain order, such order is mainly for convenience and clarity. A particular step may be repeated more than once, may occur before or after other steps, even if those steps are otherwise described in another order, and may occur in parallel with other steps. A second step is required to follow a first step only when the first step must be completed before the second step is begun. Such a situation will be specifically pointed out when not clear from the context.

In this document, the terms “and”, “or” and “and/or” are used. Such terms are to be read as having an inclusive meaning. For example, “A and B” may mean at least the following: “both A and B”, “at least both A and B”. As another example, “A or B” may mean at least the following: “at least A”, “at least B”, “both A and B”, “at least both A and B”. As another example, “A and/or B” may mean at least the following: “A and B”, “A or B”. When an exclusive-or is intended, such will be specifically noted, e.g. “either A or B”, “at most one of A and B”, etc.

This document describes various processing functions that are associated with structures such as blocks, elements, components, circuits, etc. In general, these structures may be implemented by a processor that is controlled by one or more computer programs.

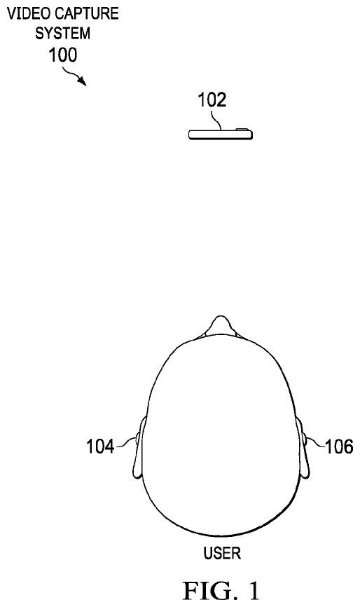

FIG. 1 is a stylized overhead view of an audiovisual capture system 100. A user generally uses the audiovisual capture system 100 to capture audio and video in an uncontrolled environment, for example to capture UGC. The audiovisual capture system 100 includes a video capture device 102, a left earbud 104, and a right earbud 106.

The video capture device 102 generally includes a camera that captures video data. The video capture device 102 may include two cameras, referred to as the front camera and the rear camera. The front camera, also referred to as the selfie camera, is generally located on one side of the video capture device 102, for example the side that includes a display screen or touchscreen. The rear camera is generally located on the side opposite to that of the front camera. The video capture device 102 may be a mobile telephone and as such may have a number of additional components and functionalities, such as processors, volatile and non-volatile memory and storage, radios, microphones, loudspeakers, etc. For example, the video capture device 102 may be a mobile telephone such as the Apple iPhone™ mobile telephone, the Samsung Galaxy™ mobile telephone, etc. The video capture device 102 may generally be held in hand by the user, mounted on the user's selfie stick or tripod, mounted on the user's shoulder mount, attached to an aerial drone, etc.

The left earbud 104 is positioned in the user's left ear, includes a microphone and generally captures a left binaural signal. The left earbud 104 provides the left binaural signal to the video capture device 102 for concurrently capturing the audio data with the video data. The left earbud 104 may connect wirelessly to the video capture device 102, for example via the IEEE 802.15.1 standard protocol, such as the Bluetooth™ protocol. Alternatively, the left earbud 104 may connect to another device, not shown, that receives both the captured audio data and the captured video data from the video capture device 102.

The right earbud 106 is positioned in the user's right ear, includes a microphone and generally captures a right binaural signal. The right earbud 104 provides the right binaural signal to the video capture device 102 in a manner similar to that described above regarding the left earbud 104. The right earbud 106 may be otherwise similar to the left earbud 104.

An example use case for the audiovisual capture system 100 is the user walking down the street and capturing video using the video capture device 102 concurrently with capturing binaural audio using the earbuds 104 and 106. The audiovisual capture system 100 then broadcasts the captured content or stores the captured content for later editing or uploading. Another example use case is recording speech for podcasts, interviews, news reporting, and during conferences or events. In such situations, binaural recording can provide a desirable sense of spaciousness; however, the presence of environmental noise and the distance of other source of interest from the person wearing the earbuds 104 and 106 often results in a less-than-optimal playback experience, due to the overwhelming presence of noise. Properly reduce the excessive noise, while keeping the spatial cue of the recording, is challenging but highly valuable in practice.

The sections below detail additional audio processing techniques implemented by the audiovisual capture system 100, for example to perform noise reduction in the captured binaural audio.

### 1. Noise Reduction in Captured Binaural Audio

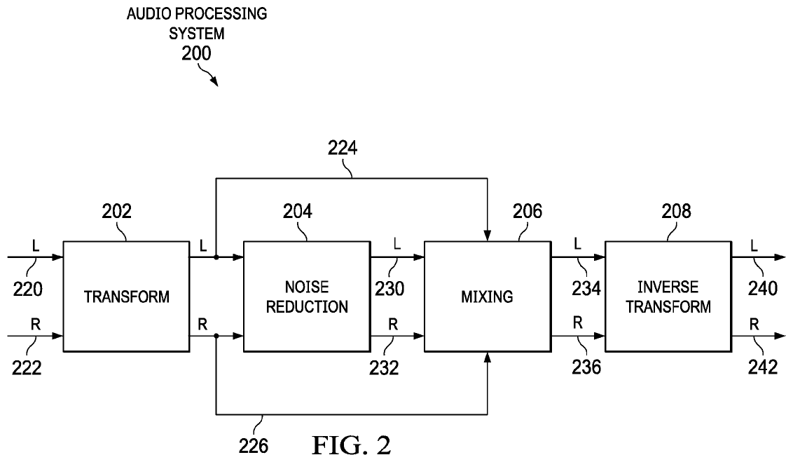

FIG. 2 is a block diagram of an audio processing system 200. The audio processing system 200 may be implemented as a component of audiovisual capture system 100 (see FIG. 1), for example as one or more computer programs executed by a processor of the video capture device 102. The audio processing system 200 includes a transform system 202, a noise reduction system 204, a mixing system 206, and an inverse transform system 208.

The transform system 202 receives a left input signal 220 and a right input signal 222, performs signal transformations, and generates a transformed left signal 224 and a transformed right signal 226. The left input signal 220 generally corresponds to the signal captured by the left earbud 104, and the right input signal 222 generally corresponds to the signal captured by the right earbud 106. In other words, the input signals 220 and 222 correspond to a binaural signal, with the left input signal 220 corresponding to the left binaural signal and the right input signal 222 corresponding to the right binaural signal. The transformed left signal 224 corresponds to the left input signal 220 having been transformed, and the transformed right signal 226 corresponds to the right input signal 222 having been transformed.

The signal transformation generally transforms the input signals from a first signal domain to a second signal domain. The first signal domain may be the time domain. The second signal domain may be the frequency domain. The signal transformation may be one or more of a Fourier transform, such as a fast Fourier transform (FFT), a short-time Fourier transform (STFT), a discrete-time Fourier transform (DTFT), a discrete Fourier transform (DFT), a discrete site transform (DST), a discrete cosine transform (DCT), etc.; a quadrature mirror filter (QMF) transform; a complex quadrature mirror filter (CQMF) transform; a hybrid complex quadrature mirror filter (HCQMF) transform; etc. The transform system 202 may perform framing of the input signal prior to performing the transform, with the transform being performed on a per-frame basis. The frame size may be between 5 and 15 ms, for example 10 ms. The transform system 202 may output the transformed signals 224 and 226 grouped into bands in the transform domain. The number of bands may be between 15 and 25, for example 20 bands.

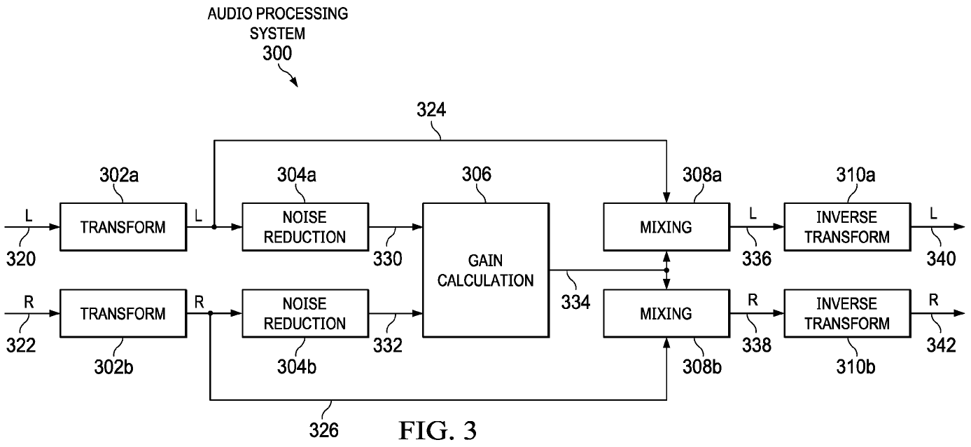

The noise reduction system 204 receives the transformed left signal 224 and the transformed right signal 226, performs gain calculation, and generates left gains 230 and right gains 232. The noise reduction system 204 generally implements one or more machine learning systems to calculate the noise reduction gains 230 and 232. In particular, the left gains 230 correspond to the noise reduction gains to be applied to the transformed left signal 224, and the right gains 232 corresponds to the noise reduction gains to be applied to the transformed right signal 226. The noise reduction gains may be shared noise reduction gains that are applied to both the left and right signals, for example a single set of gains that is applied to both signals. Further details of the machine learning systems and the noise reduction gains are provided below with particular reference to FIGS. 3-5.

The mixing system 206 receives the transformed left signal 224, the transformed right signal 226, the left gains 230 and the right gains 232, performs mixing, and generates a mixed left signal 234 and a mixed right signal 236. The mixing system 206 generally mixes the transformed left signal 224 and the left gains 230 to generate the mixed left signal 234, and mixes the transformed right signal 226 and the right gains 232 to generate the mixed right signal 236. Further details of the mixing are provided below with particular reference to FIGS. 3-5.

The inverse transform system 208 receives the mixed left signal 234 and the mixed right signal 236, performs an inverse signal transformation, and generates a modified left signal 240 and a modified right signal 242. The inverse signal transformation generally corresponds to an inverse of the signal transformation performed by the transform system 202, to transform the signal from the second signal domain back into the first signal domain. For example, the inverse transform system 208 may transform the mixed signals 234 and 236 from the QMF domain to the time domain. The modified left signal 240 then corresponds to a noise-reduced version of the left input signal 220, and the modified right signal 242 corresponds to a noise-reduced version of the right input signal 222.

The audiovisual capture system 100 may then output the modified left signal 240 and the modified right signal 242 along with a captured video signal as part of generating the UGC. Additional details of the audio processing system 200 are provided below with particular reference to FIGS. 3-5.

FIG. 3 is a block diagram of an audio processing system 300. The audio processing system 300 is a more particular embodiment of the audio processing system 200 (see FIG. 2). The audio processing system 300 may be implemented as a component of audiovisual capture system 100 (see FIG. 1), for example as one or more computer programs executed by a processor of the video capture device 102. The audio processing system 300 includes transform systems 302a and 302b, noise reduction systems 304a and 304b, a gain calculation system 306, mixing systems 308a and 308b, and inverse transform systems 310a and 310b.

The transform systems 302a and 302b receive a left input signal 320 and a right input signal 322, perform signal transformations, and generate a transformed left signal 324 and a transformed right signal 326. In particular, the transform system 302a generates the transformed left signal 324 based on the left input signal 320, and the transform system 302b generates the transformed right signal 326 based on the right input signal 322. The input signals 320 and 322 correspond to the binaural signals captured by the earbuds 104 and 106 (see FIG. 1). The signal transformations performed by the transform systems 302a and 302b generally correspond to signal transformations as discussed above regarding the transform system 202 (see FIG. 2).

The noise reduction systems 304a and 304b receive the transformed left signal 324 and the transformed right signal 326, perform gain calculation, and generate left gains 330 and right gains 332. In particular, the noise reduction system 304a generates the left gains 330 based on the transformed left signal 324, and the noise reduction system 304b generates the right gains 332 based on the transformed right signal 326. The noise reduction system 304a receives the transformed left signal 324, performs feature extraction on the transformed left signal 324 to extract a set of features, processes the set of features by inputting the set of features into a trained model, and generates the left gains 330 as a result of processing the set of features. Processing the features by inputting them into the trained model may also be referred to as “classification”. The noise reduction system 304b receives the transformed right signal 326, performs feature extraction on the transformed right signal 326 to extract a set of features, processes the set of features by inputting the set of features into the trained model, and generates the right gains 332 as a result of processing the set of features.

The features may include one or more of temporal features, spectral features, temporal-frequency features, etc. The temporal features may include one or more of autocorrection coefficients (ACC), linear prediction coding coefficients (LPCC), zero-crossing rate (ZCR), etc. The spectral features may include one or more of spectral centroid, spectral roll-off, spectral energy distribution, spectral flatness, spectral entropy, Mel-frequency cepstrum coefficients (MFCC), etc. The temporal-frequency features may include one or more of spectral flux, chroma, etc. The features may also include statistics of the other features described above. These statistics may include mean, standard deviation, and higher-order statistics, e.g., skewness, kurtosis, etc. For example, the features may include the mean and standard deviation of the spectral energy distribution.

The trained model may be implemented as part of a machine learning system. The machine learning system may include one or more neural networks such as recurrent neural networks (RNNs), convolutional neural networks (CNNs), etc. The trained model receives the extracted features as inputs, processes the extracted features, and outputs the gains as a result of the processing the extracted features. Note that the noise reduction systems 304a and 304b both use the same trained model, for example each noise reduction system implements a copy of the trained model. The trained model has been trained offline using monaural training data, as further described below.

The gain calculation system 306 receives the left gains 330 and the right gains 332, combines the gains 330 and 332 according to a mathematical function, and generates shared gains 334. The mathematical function may be one or more of a maximum, an average, a range function, a comparison function, etc. As an example, assume the left gains 330, the right gains 332 and the shared gains 334 are each a gain vector of gains, for example a vector of 20 bands. For maximum, the gain in Band 1 of the shared gains 334 is the maximum of the gain in Band 1 of the left gains 330 and the gain in Band 1 of the right gains 332; and similarly for the other 19 bands. For average, the gain in Band 1 of the shared gains 334 is the average of the gain in Band 1 of the left gains 330 and the gain in Band 1 of the right gains 332; and similarly for the other 19 bands.

The range function applies a different function to each band based on the range of the gain in each band of the gains 330 and 332. For example, when the gain in Band 1 of each of the gains 330 and 332 is less than X1, compute the maximum; when the gain is from X1 to X2, compute the average; and when the gain is more than X2, compute the maximum.

The difference function applies a different function to each band based on a comparison of the difference between the gains in each band of the gains 330 and 332. For example, when the gain difference in Band 1 of the gains 330 and 332 is less than X1, compute the average; when the gain difference is X1 or more, compute the maximum.

The audio processing system 300 uses the shared gains 334, instead of applying the left gains 330 to the transformed left signal 324 and the right gains 332 to the transformed right signal 326, in order to reduce artifacts that may be present in quick-attack sounds. A quick-attack sound captured binaurally may cross frame boundaries of the input signals 320 and 322 (as part of the operation of the transform systems 302a and 302b) due to the inter-aural time difference between the left and right microphones. In such a case, the gains for the quick-attack sound would be processed in Frame X in one channel, and in Frame X+1 in the other channel, which could result in artifacts. Computing the shared gain, e.g. the maximum of the gain in a particular band of each channel, results in a reduced perception of artifacts.

The noise reduction systems 304a and 304b, and the gain calculation system 306, may be otherwise similar to the noise reduction system 204 (see FIG. 2).

The mixing systems 308a and 308b receive the transformed left signal 324, the transformed right signal 326 and the shared gains 334, apply the shared gains 334 to the signals 324 and 326, and generate a mixed left signal 336 and a mixed right signal 338. In particular, the mixing system 308a applies the shared gains 334 to the transformed left signal 324 to generate the mixed left signal 336, and the mixing system 308b applies the shared gains 334 to the transformed right signal 326 to generate the mixed right signal 338. For example, the transformed left signal 324 may have 20 bands, the shared gains 334 may be a gain vector having 20 bands, and the magnitude value in a given band of the mixed left signal 336 results from multiplying the magnitude value of the given band in the transformed left signal 324 by the gain value of the given band in the shared gains 334. The mixing systems 308a and 308b may be otherwise similar to the mixing system 206 (see FIG. 2).

The inverse transform systems 310a and 310b receive the mixed left signal 336 and the mixed right signal 338, perform an inverse signal transformation, and generate a modified left signal 340 and a modified right signal 342. In particular, the inverse transform system 310a performs the inverse signal transformation on the mixed left signal 336 to generate the modified left signal 340, and the inverse transform system 310b performs the inverse signal transformation on the mixed right signal 338 to generate the modified right signal 342. The inverse transform performed by the inverse transform systems 310a and 310b generally corresponds to an inverse of the transform performed by the transform systems 302a and 302b, to transform the signal from the second signal domain back into the first signal domain. The modified left signal 340 then corresponds to a noise-reduced version of the left input signal 320, and the modified right signal 342 corresponds to a noise-reduced version of the right input signal 322. The inverse transform systems 310a and 310b may be otherwise similar to the inverse transform system 208 (see FIG. 2).

Monaural Model Training

As discussed above, the noise reduction systems 304a and 304b use a trained model to generate the left gains 330 and the right gains 332 from the transformed left signal 324 and the transformed right signal 326. This trained model has been trained offline using monaural training data. The offline training process may also be referred to as the training phase, which is contrasted with the operational phase when the trained model is used by the audio processing system 300 during normal operation. The training phase generally has four steps.

First, a set of training data is generated. The set of training data may be generated by mixing various monaural audio data source samples with various noise samples at various signal-to-noise ratios (SNRs). The monaural audio data source samples generally correspond to noise-free audio data, also referred to as clean audio data, including speech, music, etc. The noise samples correspond to noisy audio data, including traffic noise, fan noise, airplane noise, construction noise, sirens, baby crying, etc. The training data may result in a corpus of around 100-200 hours, from mixing around 1-2 hours of source samples with 15-25 noise samples at 5-10 SNRs. Each source sample may be between 15-60 seconds, and the SNRs may range from −45 to 0 dB. For example, a given source sample of speech may be 30 seconds, and the given source sample may be mixed with a noise sample of traffic noise at 5 SNRs of −40, −30, −20, −10 and 0 dB, resulting in 600 seconds of training data in the corpus of training data.

Second, features are extracted from the set of training data. Generally, the feature extraction process will be the same as those to be used during the operation of the audio processing system, for example 200 (see FIG. 2) or 300 (see FIG. 3), etc., such as performing a transform and extracting the features in the second signal domain. The features extracted will also correspond to those to be used during the operation of the audio processing system.

Third, the model is trained on the set of training data. In general, training occurs by adjusting the weights of the nodes in the model in response to comparing the output of the model with an ideal output. The ideal output corresponds to the gains required to adjust a noisy input to become a noise-free output.

Finally, once the model has been trained sufficiently, the resulting model is provided to the audio processing system, e.g. 200 in FIG. 2 or 300 in FIG. 3, for use in the operational phase.

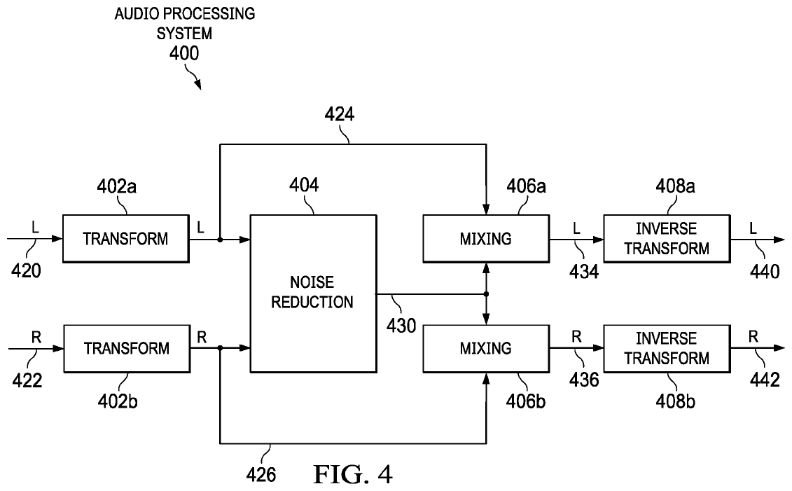

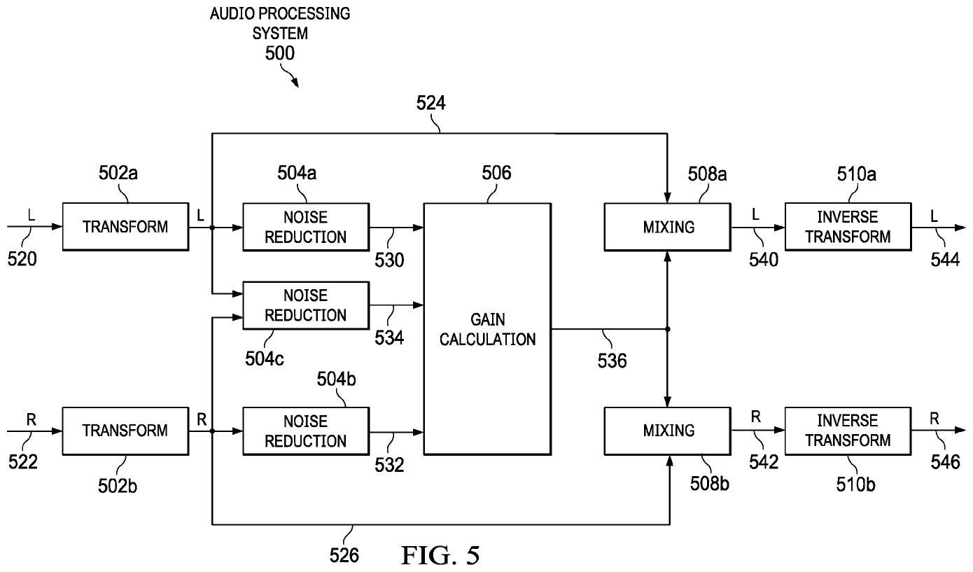

As discussed above, the training data is monaural training data. This monaural training data results in a single model that the audio processing system 300 uses on each input channel. Specifically, the noise reduction system 304a uses the trained model with the transformed left signal 324 as input, and the noise reduction system 304b uses the trained model with the transformed right signal 326 as input; for example, the systems 304a and 304b may each implement a copy of the trained model. Models may also be trained using binaural training data, as discussed below regarding FIGS. 4-5.

FIG. 4 is a block diagram of an audio processing system 400. The audio processing system 400 is a more particular embodiment of the audio processing system 200 (see FIG. 2). The audio processing system 400 may be implemented as a component of audiovisual capture system 100 (see FIG. 1), for example as one or more computer programs executed by a processor of the video capture device 102. The audio processing system 400 is similar to the audio processing system 300 (see FIG. 3), with differences related to the trained model, as detailed below. The audio processing system 400 includes transform systems 402a and 402b, a noise reduction system 404, mixing systems 406a and 406b, and inverse transform systems 408a and 408b.

The transform systems 402a and 402b receive a left input signal 420 and a right input signal 422, perform signal transformations, and generate a transformed left signal 424 and a transformed right signal 426. The transform systems 402a and 402b operate in a manner similar to that of the transform systems 302a and 302b (see FIG. 3) and for brevity that description is not repeated.

The noise reduction system 404 receives the transformed left signal 424 and the transformed right signal 426, performs gain calculation, and generates joint gains 430. The joint gains 430 are based on both the transformed left signal 424 and the transformed right signal 426. The noise reduction system 404 performs feature extraction on the transformed left signal 424 and the transformed right signal 426 to extract a joint set of features, processes the joint set of features by inputting the joint set of features into a trained model, and generates the joint gains 430 as a result of processing the joint set of features. The joint gains 430 thus correspond to shared gains, and may also be referred to as the shared gains 430. The noise reduction system 404 is otherwise similar to the noise reduction systems 304a and 304b (see FIG. 3), and for brevity that description is not repeated. For example, the joint set of features may be features similar to those discussed above regarding the noise reduction systems 304a and 304b. The trained model is similar to the trained model discussed above regarding the noise reduction systems 304a and 304b, except that the trained model implemented by the noise reduction system 404 has been trained offline using binaural training data, as further described below.

Note that the audio processing system 400 need not have a gain calculation system, unlike the audio processing system 300 (see FIG. 3), because the noise reduction system 404 outputs the shared gains 430 as a result of having been trained using binaural training data.

The mixing systems 406a and 406b receive the transformed left signal 424, the transformed right signal 426 and the shared gains 430, applies the shared gains 430 to the signals 424 and 426, and generates a mixed left signal 434 and a mixed right signal 436. In particular, the mixing system 406a applies the shared gains 430 to the transformed left signal 424 to generate the mixed left signal 434, and the mixing system 406b applies the shared gains 430 to the transformed right signal 426 to generate the mixed right signal 436. The mixing systems 406a and 406b are otherwise similar to the mixing systems 308a and 308b (see FIG. 3), and for brevity that description is not repeated.

The inverse transform systems 408a and 408b receive the mixed left signal 434 and the mixed right signal 436, perform an inverse signal transformation, and generate a modified left signal 440 and a modified right signal 442. In particular, the inverse transform system 408a performs the inverse signal transformation on the mixed left signal 434 to generate the modified left signal 440, and the inverse transform system 408b performs the inverse signal transformation on the mixed right signal 436 to generate the modified right signal 442. The inverse transform performed by the inverse transform systems 408a and 408b generally corresponds to an inverse of the transform performed by the transform systems 402a and 402b, to transform the signal from the second signal domain back into the first signal domain. The modified left signal 440 then corresponds to a noise-reduced version of the left input signal 420, and the modified right signal 442 corresponds to a noise-reduced version of the right input signal 422. The inverse transform systems 408a and 408b may be otherwise similar to the inverse transform systems 310a and 310b (see FIG. 3).

Binaural Model Training

As discussed above, the noise reduction system 404 uses a trained model to generate the shared gains 430 from the transformed left signal 424 and the transformed right signal 426. The trained model has been trained offline using binaural training data. The use of binaural training data contrasts with the use of monaural training data as used when training the model for the noise reduction systems 304a and 304b (see FIG. 3). Training the model using binaural training data is generally similar to training the model using monaural training data as discussed above regarding FIG. 3, and the training phase generally has four steps.

First, a set of training data is generated. The audio data source samples are binaural audio data source samples, instead of the monaural audio data source samples as discussed above regarding FIG. 3. Mixing the binaural audio data source samples with the noise samples at various SNRs results in a similar corpus of around 100-200 hours.

Second, features are extracted from the set of training data. The features are extracted from the binaural channels in combination, e.g. the left and right channels in combination. Extracting the features from the binaural channels in combination contrasts with the extraction from a single channel as used when training the model for the noise reduction systems 304a and 304b (see FIG. 3).

Third, the model is trained on the set of training data. The training process is generally similar to the training process as used when training the model for the noise reduction systems 304a and 304b (see FIG. 3).

Finally, once the model has been trained sufficiently, the resulting model is provided to the audio processing system, e.g. 400 in FIG. 4, for use in the operational phase.

FIG. 5 is a block diagram of an audio processing system 500. The audio processing system 500 is a more particular embodiment of the audio processing system 200 (see FIG. 2). The audio processing system 500 may be implemented as a component of audiovisual capture system 100 (see FIG. 1), for example as one or more computer programs executed by a processor of the video capture device 102. The audio processing system 500 is similar to both the audio processing system 300 (see FIG. 3) and the audio processing system 400 (see FIG. 4), with differences related to the trained models, as detailed below. The audio processing system 500 includes transform systems 502a and 502b, noise reduction systems 504a, 504b and 504c, a gain calculation system 506, mixing systems 508a and 508b, and inverse transform systems 510a and 510b.

The transform systems 502a and 502b receive a left input signal 520 and a right input signal 522, perform signal transformations, and generate a transformed left signal 524 and a transformed right signal 526. The transform systems 502a and 502b operate in a manner similar to that of the transform systems 302a and 302b (see FIG. 3) or 402a and 402b (see FIG. 4) and for brevity that description is not repeated.

The noise reduction systems 504a, 504b and 504c receive the transformed left signal 524 and the transformed right signal 526, perform gain calculation, and generate left gains 530, right gains 532, and joint gains 534. In particular, the noise reduction system 504a generates the left gains 530 based on the transformed left signal 524, the noise reduction system 504b generates the right gains 532 based on the transformed right signal 326, and the noise reduction system 504c generates the joint gains 534 based on both the transformed left signal 524 and the transformed right signal 526. The noise reduction system 504a receives the transformed left signal 524, performs feature extraction on the transformed left signal 524 to extract a set of features, processes the set of features by inputting the set of features into a trained monaural model, and generates the left gains 530 as a result of processing the set of features. The noise reduction system 504b receives the transformed right signal 526, performs feature extraction on the transformed right signal 526 to extract a set of features, processes the set of features by inputting the set of features into the trained monaural model, and generates the right gains 532 as a result of processing the set of features. The noise reduction system 504c receives the transformed left signal 524 and the transformed right signal 526, performs feature extraction on the transformed left signal 524 and the transformed right signal 526 to extract a joint set of features, processes the joint set of features by inputting the joint set of features into a trained binaural model, and generates the joint gains 534 as a result of processing the joint set of features. The noise reduction systems 504a and 504b are otherwise similar to the noise reduction systems 304a and 304b (see FIG. 3), and the noise reduction system 504c is otherwise similar to the noise reduction system 404 (see FIG. 4); for brevity that description is not repeated.

In summary, the noise reduction systems 504a and 504b implement a machine learning system using a monaural model similar to that of the audio processing system 300 (see FIG. 3), and the noise reduction system 504c implements a machine learning system using a binaural model similar to that of the audio processing system 400 (see FIG. 4). The audio processing system 500 may thus be viewed as a combination of the audio processing systems 300 and 400.

The gain calculation system 506 receives the left gains 530, the right gains 532 and the joint gains 534, combines the gains 530, 532 and 534 according to a mathematical function, and generates shared gains 536. The mathematical function may be one or more of a maximum, an average, a range function, a comparison function, etc. The gains 530, 532 and 534 may be gain vectors of banded gains, with the mathematical function being applied to a given band respectively in the gains 530, 532 and 534. The gain calculation system 506 may be otherwise similar to the gain calculation system 306 (see FIG. 3), and for brevity that description is not repeated.

The mixing systems 508a and 508b receive the transformed left signal 524, the transformed right signal 526 and the shared gains 536, apply the shared gains 536 to the signals 524 and 526, and generate a mixed left signal 540 and a mixed right signal 542. In particular, the mixing system 508a applies the shared gains 536 to the transformed left signal 524 to generate the mixed left signal 540, and the mixing system 508b applies the shared gains 536 to the transformed right signal 526 to generate the mixed right signal 542. The mixing systems 508a and 508b may be otherwise similar to the mixing systems 308a and 308b (see FIG. 3), and for brevity that description is not repeated.

The inverse transform systems 510a and 510b receive the mixed left signal 540 and the mixed right signal 542, perform an inverse signal transformation, and generate a modified left signal 544 and a modified right signal 546. In particular, the inverse transform system 510a performs the inverse signal transformation on the mixed left signal 540 to generate the modified left signal 544, and the inverse transform system 510b performs the inverse signal transformation on the mixed right signal 542 to generate the modified right signal 546. The inverse transform performed by the inverse transform systems 510a and 510b generally corresponds to an inverse of the transform performed by the transform systems 502a and 502b, to transform the signal from the second signal domain back into the first signal domain. The modified left signal 544 then corresponds to a noise-reduced version of the left input signal 520, and the modified right signal 546 corresponds to a noise-reduced version of the right input signal 522. The inverse transform systems 510a and 510b may be otherwise similar to the inverse transform systems 310a and 310b (see FIG. 3) or 408a and 408b (see FIG. 4).

Model Training

As discussed above, the noise reduction systems 504a, 504b and 504c use a trained monaural model and a trained binaural model to generate the gains 530, 532 and 534 from the transformed left signal 524 and the transformed right signal 526. Training the monaural model is generally similar to training the model used by the noise reduction systems 304a and 304b (see FIG. 3), and training the binaural model is generally similar to training the model used by the noise reduction system 404 (see FIG. 4), and for brevity that description is not repeated.

### 2. Combined Binaural Audio and Video Capture

As mentioned above, UGC often includes combined audio and video capture. The concurrent capture of video and binaural audio is especially challenging. One such challenge is when the binaural audio capture and the video capture are performed by separate devices, for example with a mobile telephone capturing the video and earbuds capturing the binaural audio. A mobile telephone generally includes two cameras, the front camera, also referred to as the selfie camera, and the back camera, also referred to as the main camera. When the back (main) camera is in use, this may be referred to as normal mode; when the front (selfie) camera is in use, this may be referred to as selfie mode. In normal mode, the user holding the video capture device is behind the scene captured on video. In selfie mode, the user holding the video capture device is present in the scene captured on video.

When the binaural audio capture and the video capture are performed by separate devices, there may be a mismatch between the captured video data and the captured binaural audio data, when compared with human perception of the environment with eyes and ears. One example of such mismatches includes the perception of the binaural audio captured concurrently with video in normal mode, versus the perception of the binaural audio captured concurrently with video in selfie mode. Another example of such mismatches includes discontinuities introduced when switching between normal mode and selfie mode. The following sections describe various processes to correct these mismatches.

### 3. Binaural Audio Capture in Selfie Mode

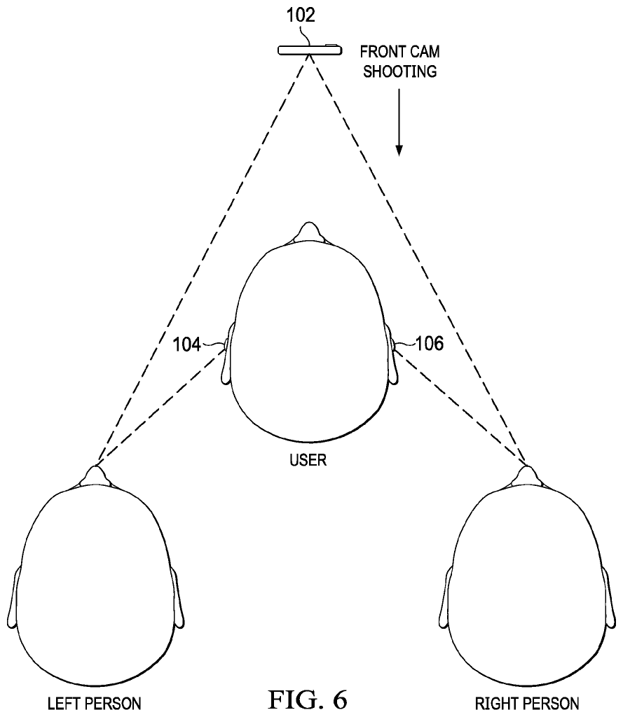

FIG. 6 is a stylized overhead view illustrating binaural audio capture in selfie mode using the video capture system 100 (see FIG. 1). The video capture device 102 is in selfie mode and uses the front camera to capture video that includes the user in the scene. The user is wearing the earbuds 104 and 106 to capture binaural audio of the scene. The video capture device 102 is between about 0.5 and 1.5 meters in front of the user, depending upon whether the user is holding the video capture device 102 in hand, is using a selfie stick to hold the video capture device 102, etc. The video capture device 102 may also capture other persons nearby the user, for example a person behind the user on the user's left, referred to as the left person, and a person behind the user on the user's right, referred to as the right person. Because the audio is captured binaurally, listeners will perceive sounds made by the left person as originating behind and to the left, and the listeners will perceive sounds made by the right person as originating behind and to the right. This involves a number of corrections in selfie mode.

3.1 Left/Right Correction

The opposite orientation of user wearing the earbuds 104 and 106 and the front (selfie) camera of the video capture device 102 will result in a left/right flip of the captured binaural audio content. A consumer of the captured audiovisual content will perceive the sound coming from the right earbud as coming from sources that appear on the left side of the video, and the sound coming from the left earbud as coming from sources that appear on the right side of the video, which is inconsistent with our experience when we see objects with eyes and hear them with ears.

The left/right correction involves taking the left channel from the input and sending it to the right channel of the output, or expressed R′=L as an equation; and taking the right channel from the input and sending it to the left channel of the output, or expressed L′=R as an equation.

3.2 Front/Back Correction

To record other speakers in the same scene when using the front (selfie) camera, oftentimes the user who wears the earbuds 104 and 106 and holds the video capture device 102 stands a bit in front of the other speakers, i.e., closer to the camera. Thus, for the captured binaural audio, speech of other speakers will come from behind the listener who consumes the content. On the other hand, the captured video will show all speakers in the front.

To correct this in general, and to enhance the perceptual consistency between audio and video, embodiments may implement front/back correction, which operates to modify the spectral shape of sounds coming from behind of the listener so that the sounds are perceived in a manner similar to sounds that are coming from the front.

The embodiments disclosed herein may implement spectral shape modification using a high-shelf filter. A high-shelf filter can be built in various ways. For example, it can be implemented using an infinite impulse response (IIR) filter, for example a bi-quad filter.

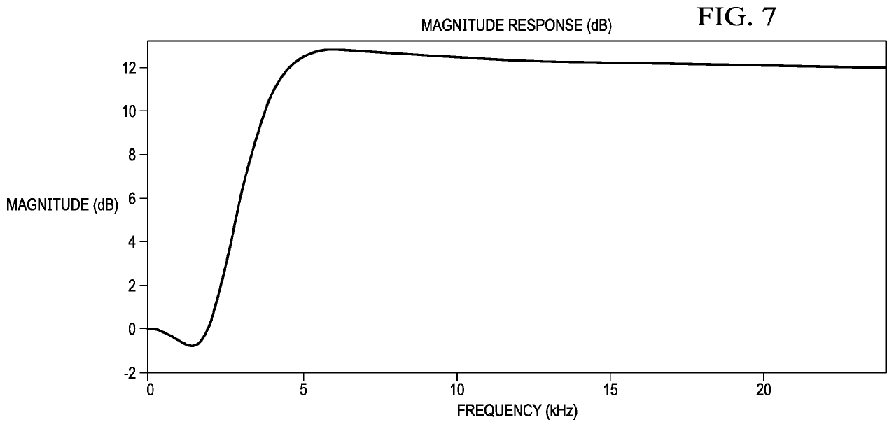

FIG. 7 is a graph showing an example of the magnitude response of a high-shelf filter implemented using a bi-quad filter. In FIG. 7, the x-axis is the frequency in kHz, and the y-axis is the magnitude of the loudness adjustment the filter applies to the signal. The high-shelf frequency in this example is about 3 kHz, which is a typical value, given the shading effect of human heads. Because the rear captured audio is attenuated at the higher frequencies, such as 5 kHz and above as shown in FIG. 7, the filter implements a high shelf to boost these frequencies when the audio is corrected to the front.

The embodiments disclosed herein may also implement the spectral shape modification using an equalizer. An equalizer boosts or attenuates the input audio in one or more bands with different gains and may be implemented by IIR filters or finite impulse response (FIR) filters. Equalizers can shape the spectrum with higher accuracy, and a typical configuration is a boost of 8 to 12 dB, in the frequency range of 3 to 8 kHz, for front/back correction.

3.3 Stereo Image Width Control

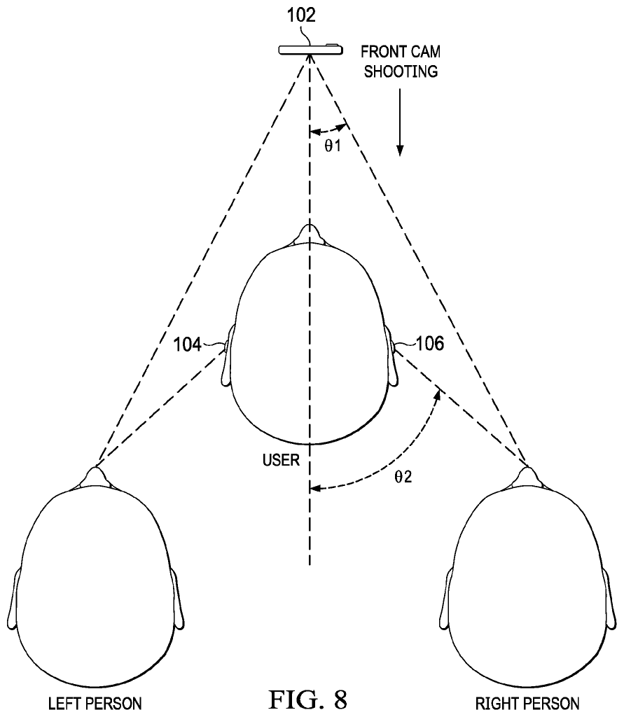

FIG. 8 is a stylized overhead view showing various audio capture angles in selfie mode. The angle θ1 corresponds to the angle of the sound of the right person captured by microphones on the video capture device 102 (see FIG. 6), and the angle θ2 corresponds to the angle of the sound of the right person captured by the right earbud 106. As compared to the case in which the microphones are on the video capture device 102, the earbuds 104 and 106 are usually closer to the line where the other speakers would normally stand, thus we have θ2>θ1, which means the speech of other speakers come from directions closer to the sides, whereas based on the video scene, a viewer would expect the speech come from directions closer to the middle.

To address this issue, embodiments may implement stereo image width control to improve the consistency between video and binaural audio recording by compressing the perceived width of the binaural audio. In one implementation, the compression is achieved by attenuation of side component of the binaural audio. Firstly, the input binaural audio is converted to middle-side representation according to Equations (1.1) and (1.2):

M=0.5(L+R) (1.1)

S=0.5(L−R) (1.2)

In Equations (1.1) and (1.2), L and R are the left and right channels of the input audio, for example the left and right input signals 220 and 222 in FIG. 2, whereas M and S are the middle and side components resulting from the conversion.

Then the side channel S is attenuated by an attenuation factor α, and the processed output audio L′ and R′ is given by Equations (2.1) and (2.2):

L′=M+αS (2.1)

R′=M−αS (2.2)

The attenuation factor α can be a function of the focal length f of the front (selfie) camera, given by Equation (3):

$$α = {( \frac{f}{{f}_{c}} )}^{\frac{1}{γ}} \qquad ( 3 )$$

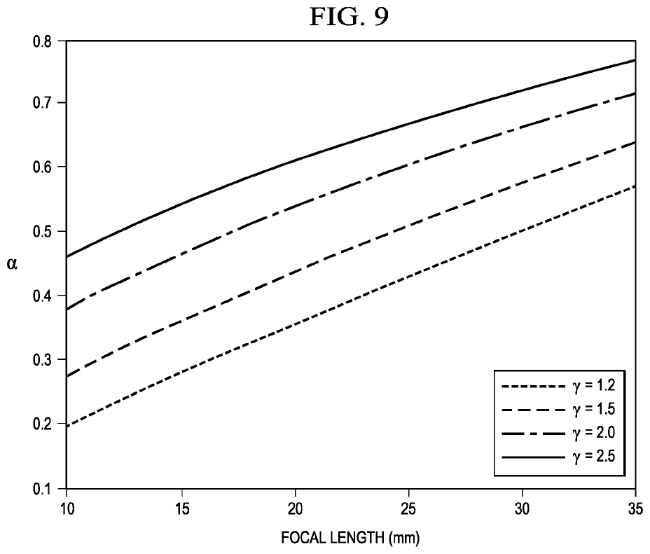

In Equation (3), f_{c} is the focal length at which we expect α=1, i.e. no attenuation of the side component S is applied, also referred to as the baseline focal length; and γ is an aggressiveness factor, as further detailed with reference to FIG. 9.

FIG. 9 is a graph of the attenuation factor α for different focal lengths f. In FIG. 9, the x-axis is the focal length f ranging between 10 and 35 mm, the y-axis is the attenuation factor α, the baseline focal length f_{c} is 70 mm, and the aggressiveness factor γ is selectable from [1.2 1.5 2.0 2.5]. The aggressiveness factor γ may be selectable by the device manufacturer in order to provide various options for the camera. For a typical front (selfie) camera on smartphones with f=30 mm, α is in the range of 0.5 to 0.7.

In summary, when video is captured with a smaller focal length, it will appear zoomed out and the captured audio of the left person and the right person will all appear to originate from the center of the video, so width control corrects the captured audio by shrinking the audio scene to match the video scene.

### 4. Binaural Audio Capture in Normal Mode

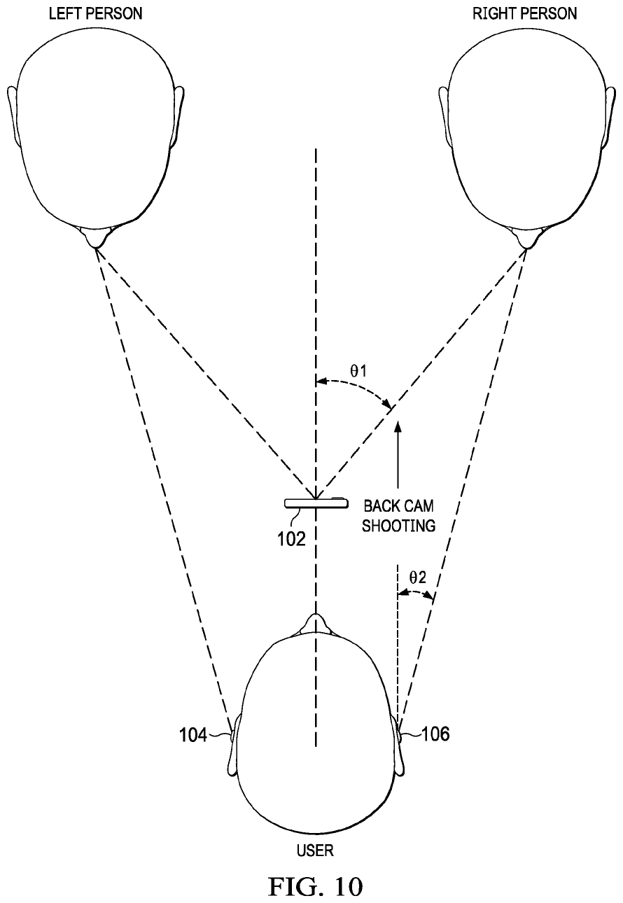

FIG. 10 is a stylized overhead view illustrating binaural audio capture in normal mode using the video capture system 100 (see FIG. 1). The video capture device 102 is in normal mode and uses the rear camera to capture video that does not include the user in the scene. The user is wearing the earbuds 104 and 106 to capture binaural audio of the scene. As opposed to selfie mode (see FIGS. 6 and 8), where the user is often captured in the video scene, in normal mode the user is not often captured in the video scene. In normal mode, the user wearing the earbuds 104 and 106 and holding the video capture device 102 is usually behind the video scene. The other people are usually in the front, to be captured in the video, as shown with the left person and the right person. The angle θ1 corresponds to the angle of the sound of the right person captured by microphones on the video capture device 102, and the angle θ2 corresponds to the angle of the sound of the right person captured by the right earbud 106.

In normal mode, there is no need for the audio processing system to perform either left/right correction or front/back correction, as may be performed in selfie mode. As for the stereo image width control, compared to the case in which the microphones are on the video capture device 102, the earbuds 104 and 106 are usually farther away to the line where the other speakers would normally stand, thus we have θ2<θ1, so in this mode the perceived width of the binaural audio can be made to be a bit wider. However, the difference between θ1 and θ2 are less significant compared to selfie mode, so for simplicity, a typical approach is to keep the binaural audio as-is.

### 5. Switching Between Normal Mode and Selfie Mode

Different audio processing will often be applied in normal mode as compared to selfie mode. For example, left/right correction is performed in selfie mode but not in normal mode. When the user switches modes, it is beneficial for the audio processing system to perform the switching smoothly. The switching may be performed during real-time operation, for example when capturing content for broadcasting or streaming, as well as during non-real-time operation, for example when capturing content for later processing or uploading.

5.1 Smoothing for Left/Right Correction and Stereo Image Width Control

Recall from Section 3, we have L′=R and R′=L as the equations for performing left/right correction. These can be rewritten as Equations (4.1-4.4):

M=0.5(L+R) (4.1)

S=0.5(L−R) (4.2)

L′=M+αS (4.3)

R′=M−αS (4.4)

In Equations (4.1-4.4), the attenuation factor α=−1 for left/right correction in selfie mode.

Because no left/right correction is needed for normal mode, α=−1 in that mode. Therefore, during a switch between normal mode and selfie mode, a switches between 1 and −1. To ensure the switch is smooth, a should change its value gradually. One example of an equation for performing a smooth transition is given by Equation (5):

$$α = \{ \begin{matrix}- 1 , t \leq {t}_{s} - 0.5 \\ 2 ( t - {t}_{s} ) , {t}_{s} - 0.5 < t < {t}_{s} + 0.5 \\ 1 , t \geq {t}_{s} + 0.5\end{matrix} \qquad ( 5 )$$

In Equation (5), tₛ is the time at which the switch is performed, and a transition time of 1 second works well for the left/right correction switching. Hence, the transition starts at tₛ−0.5 and ends at tₛ+0.5 for non-real-time cases. For real-time cases, Equation (5) may be modified to start at tₛ and to end at 1 second. The value of 1 second may be adjusted as desired, e.g. in the range of 0.5 to 1.5 seconds.

Stereo image width control uses a similar set of expressions, as represented by Equations (6.1-6.4):

M=0.5(L+R) (6.1)

S=0.5(L−R) (6.2)

L′=M+αS (6.3)

R′=M−αS (6.4)

However, in Equations (6.1-6.4) the attenuation factor α is in the range of 0.5 to 0.7 for selfie mode, and 1.0 for normal mode.

In other words, the stereo image width control includes generating the middle channel M and the side channel S, attenuating the side channel by a width adjustment factor α, and generating a modified audio signal L′ and R′ from the middle channel and the side channel having been attenuated. The width adjustment factor is calculated based on a focal length of the video capture device, and the width adjustment factor may be updated in real time in response to the video capture device changing the focal length in real time.

Combining the smoothing for stereo image width control and left/right correction together, we have a in the range of −0.5 to −0.7 for selfie mode, and 1.0 for normal mode. Assuming α=−0.5 as an example results in Equation (7):

$$α = \{ \begin{matrix}- 0.5 , & t \leq {t}_{s} - 0.5 \\ 1.5 ( t - {t}_{s} ) + 0.25 , & {t}_{s} - 0.5 < t < {t}_{s} + 0.5 \\ {1}_{t} & t \geq {t}_{s} + 0.5\end{matrix} \qquad ( 7 )$$

In Equation (7), tₛ is the time at which the switch is performed, and a transition time of 1 second works well for the combined left/right correction switching and stereo image width control switching. Hence, the transition starts at tₛ−0.5 and ends at tₛ+0.5 for non-real-time cases. For real-time cases, Equation (7) may be modified to start at tₛ and to end at 1 second. The value of 1 second may be adjusted as desired, e.g. in the range of 0.5 to 1.5 seconds.

5.2 Smoothing for Front/Back Correction

As described in Sections 3 and 4, in selfie mode, front/back correction is applied as a spectral reshape, and in normal mode, front/back correction is not applied.

Let x_{orig} be the input to front/back correction, and x_{fb} denote the output of front/back correction. Then the smoothed output of front/back correction is given by Equation (8):

x_{smoothed}=αx_{orig}+(1−α)x_{fb} (8)

In Equation (8), α=0 is the case for selfie mode, and α=1 is the case for normal mode. An example of an equation for the smoothed transition is given by Equation (9):

$$α = \{ \begin{matrix} \\ \\ \end{matrix} \begin{matrix}0 , & t \leq {t}_{s} - 3 \\ \frac{( t - {t}_{s} )}{6} + 0 \text{.5} , & {t}_{s} - 3 < t < {t}_{s} + 3 \\ 1 , & t \geq {t}_{s} + 3\end{matrix} \qquad ( 9 )$$

In Equation (9), tₛ is the time at which the switch is performed, and a transition time of 6 second works well for front/back correction. Hence, the transition starts at tₛ−3 and ends at tₛ+3 for non-real-time cases. For real-time cases, Equation (9) may be modified to start at tₛ and to end at 6 seconds. The value of 6 second may be adjusted as desired, e.g. in the range of 3 to 9 seconds.

The front/back smoothing uses a longer transition time (e.g., 6 seconds) than used for left/right and stereo image width smoothing (e.g., 1 second) because the front/back transition involves a timbre change, which is made less perceptible by using the longer transition time.

### 6. Example Device Architecture

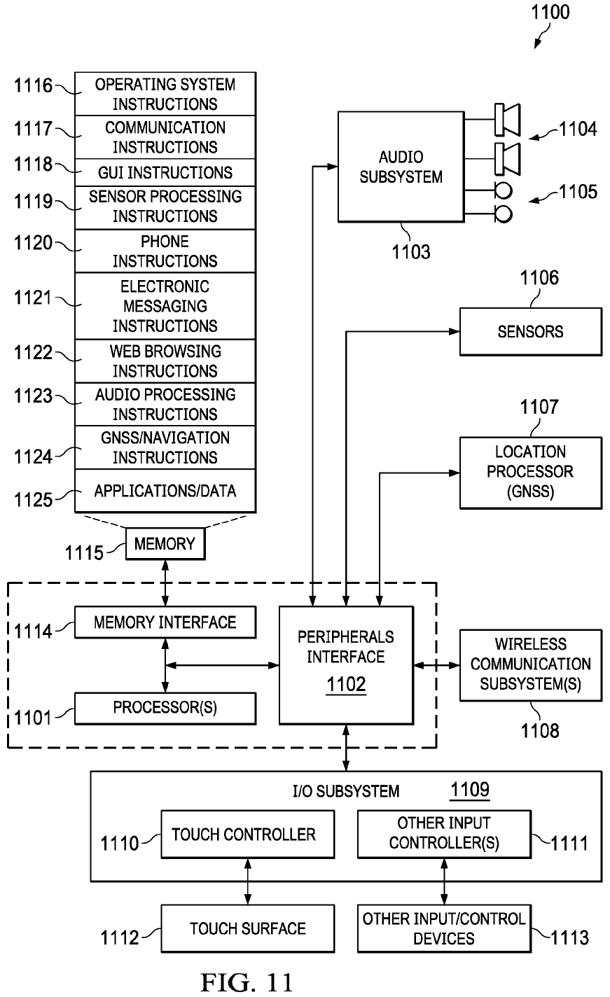

FIG. 11 is a device architecture 1100 for implementing the features and processes described herein, according to an embodiment. The architecture 1100 may be implemented in any electronic device, including but not limited to: a desktop computer, consumer audio/visual (AV) equipment, radio broadcast equipment, mobile devices, e.g. smartphone, tablet computer, laptop computer, wearable device, etc. In the example embodiment shown, the architecture 1100 is for a mobile telephone. The architecture 1100 includes processor(s) 1101, peripherals interface 1102, audio subsystem 1103, loudspeakers 1104, microphone 1105, sensors 1106, e.g. accelerometers, gyros, barometer, magnetometer, camera, etc., location processor 1107, e.g. GNSS receiver, etc., wireless communications subsystems 1108, e.g. Wi-Fi, Bluetooth, cellular, etc., and I/O subsystem(s) 1109, which includes touch controller 1110 and other input controllers 1111, touch surface 1112 and other input/control devices 1113. Other architectures with more or fewer components can also be used to implement the disclosed embodiments.

Memory interface 1114 is coupled to processors 1101, peripherals interface 1102 and memory 1115, e.g., flash, RAM, ROM, etc. Memory 1115 stores computer program instructions and data, including but not limited to: operating system instructions 1116, communication instructions 1117, GUI instructions 1118, sensor processing instructions 1119, phone instructions 1120, electronic messaging instructions 1121, web browsing instructions 1122, audio processing instructions 1123, GNSS/navigation instructions 1124 and applications/data 1125. Audio processing instructions 1123 include instructions for performing the audio processing described herein.

According to an embodiment, the architecture 1100 may correspond to a mobile telephone that captures video data, and that connects to earbuds that capture binaural audio data (see FIG. 1).

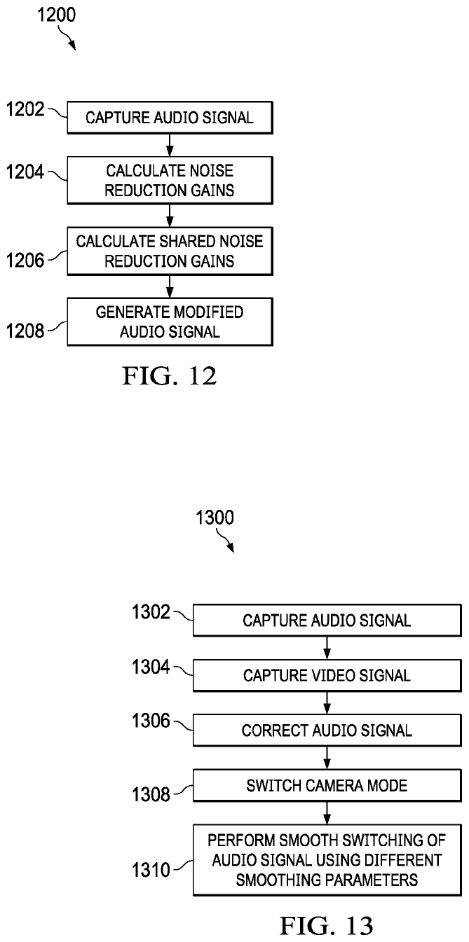

FIG. 12 is a flowchart of a method 1200 of audio processing. The method 1200 may be performed by a device, e.g. a laptop computer, a mobile telephone, etc., with the components of the architecture 1100 of FIG. 11, to implement the functionality of the video capture system 100 (see FIG. 1), the audio processing system 200 (see FIG. 2), etc., for example by executing one or more computer programs.

At 1202, an audio signal is captured by an audio capturing device. The audio signal has at least two channels including a left channel and a right channel. For example, the left earbud 104 (see FIG. 1) may capture the left channel (e.g., 220 in FIG. 2), and the right earbud 106 may capture the right channel (e.g., 222 in FIG. 2).

At 1204, noise reduction gains for each channel of the at least two channels are calculated by a machine learning system. The machine learning system may perform feature extraction, may processes the extracted features by inputting the extracted features into a trained model, and may output the noise reduction gains as a result of processing the features. The trained model may be a monaural model, a binaural model, or both a monaural model and a binaural model. At 1206, shared noise reduction gains are calculated based on the noise reduction gains for each channel.

The steps 1204 and 1206 may be performed as individual steps, or as sub-steps of a combined operation. For example, the noise reduction system 204 (see FIG. 2) may calculate the left gains 230 and right gains 232 as shared noise reduction gains. As another example, the noise reduction system 304a (see FIG. 3) may generate the left gains 330, and the noise reduction system 304b may generate the right gains 332; the gain calculation system 306 may then generate the shared gains 334 by combining the gains 330 and 332 according to the mathematical function. As another example, the noise reduction system 404 (see FIG. 4) may calculate the joint gains 430 as shared noise reduction gains. As another example, the noise reduction system 504a (see FIG. 5) may generate the left gains 530, the noise reduction system 504b may generate the right gains 532, and the noise reduction system 504c may generate the joint gains 534; the gain calculation system 506 may then generate the shared gains 536 by combining the gains 530, 532 and 534 according to the mathematical function.

At 1208, a modified audio signal is generated by applying the plurality of shared noise reduction gains to each channel of the at least two channels. For example, the mixing system 206 (see FIG. 2) may generate the mixed left signal 234 and the mixed right signal 236 by applying the left gains 230 and the right gains 232 to the transformed left signal 224 and the transformed right signal 226. As another example, the mixing system 308a (see FIG. 3) may generate the mixed left signal 336 by applying the shared gains 334 to the transformed left signal 324, and the mixing system 308b may generate the mixed right signal 338 by applying the shared gains 334 to the transformed right signal 326. As another example, the mixing system 406a (see FIG. 4) may generate the mixed left signal 434 by applying the shared gains 430 to the transformed left signal 424, and the mixing system 406b may generate the mixed right signal 436 by applying the shared gains 430 to the transformed right signal 426. As another example, the mixing system 508a (see FIG. 5) may generate the mixed left signal 540 by applying the shared gains 536 to the transformed left signal 524, and the mixing system 508b may generate the mixed right signal 542 by applying the shared gains 536 to the transformed right signal 526.

The method 1200 may include additional steps corresponding to the other functionalities of the audio processing systems as described herein. One such functionality is transforming the audio signal from a first signal domain to a second signal domain, performing the audio processing in the second signal domain, and transforming the processed audio signal back into the first signal domain, e.g. using the transform system 202 and the inverse transform system 208 of FIG. 2. Another such functionality is contemporaneous video capture and audio capture, including one or more of front/back correction, left/right correction, and stereo image width control correction, e.g. as discussed in Sections 3-4. Another such functionality is smooth switching between selfie mode and normal mode, including smoothing the left/right correction using a first smoothing parameter and smoothing the front/back correction using a second smoothing parameter, e.g. as discussed in Section 5.

### 7. Alternative Embodiments

Although many of the features are discussed above in combination, this is mainly due to the synergies resulting from the combination. Many of the features may be implemented independently of the others while still resulting in advantages over existing systems.

7.1 Single Camera Systems

Although some of the features herein are described in the context of the video capture device having two cameras, many of the features are also applicable to video capture devices having a single camera. For example, a single camera system still benefits from the binaural adjustments performed in normal mode as described in Section 4.

7.2 Smooth Switching of Video Capture Modes

FIG. 13 is a flowchart of a method 1300 of audio processing. Although the method 1200 (see FIG. 12) performs noise reduction, with smooth switching as an additional functionality as described in Section 5, the smooth switching may be performed independently of the noise reduction. The method 1300 describes performing the smooth switching independently of noise reduction. The method 1300 may be performed by a device, e.g. a laptop computer, a mobile telephone, etc., with the components of the architecture 1100 of FIG. 11, to implement the functionality of the video capture system 100 (see FIG. 1), etc., for example by executing one or more computer programs.

At 1302, an audio signal is captured by an audio capturing device. The audio signal has at least two channels including a left channel and a right channel. For example, the left earbud 104 (see FIG. 1) may capture the left channel (e.g., 220 in FIG. 2), and the right earbud 106 may capture the right channel (e.g., 222 in FIG. 2).

At 1304, a video signal is captured by a video capturing device, contemporaneously with capturing the audio signal (see 1302). For example, the video capture device 102 (see FIG. 1) may capture a video signal contemporaneously with the earbuds 104 and 106 capturing a binaural audio signal.

At 1306, the audio signal is corrected to generate a corrected audio signal. The correction may include one or more of front/back correction, left/right correction, and stereo image width correction.

At 1308, the video signal is switched from a first camera mode to a second camera mode. For example, the video capture device 102 (see FIG. 1) may switch from the selfie mode (see FIGS. 6 and 8) to the normal mode (see FIG. 10), or from the normal mode to the selfie mode.

At 1310, smooth switching of the corrected audio signal is performed contemporaneously with switching the video signal (see 1308). The smooth switching may use a first smoothing parameter for smoothing one type of correction (e.g., the left/right smoothing uses Equation (5), or the combined left/right and stereo image width smoothing uses Equation (7)), and a second smoothing parameter for smoothing another type of correction (e.g., the front/back correction uses Equation (9)).

Implementation Details

An embodiment may be implemented in hardware, executable modules stored on a computer readable medium, or a combination of both, e.g. programmable logic arrays, etc. Unless otherwise specified, the steps executed by embodiments need not inherently be related to any particular computer or other apparatus, although they may be in certain embodiments. In particular, various general-purpose machines may be used with programs written in accordance with the teachings herein, or it may be more convenient to construct more specialized apparatus, e.g. integrated circuits, etc., to perform the required method steps. Thus, embodiments may be implemented in one or more computer programs executing on one or more programmable computer systems each comprising at least one processor, at least one data storage system, including volatile and non-volatile memory and/or storage elements, at least one input device or port, and at least one output device or port. Program code is applied to input data to perform the functions described herein and generate output information. The output information is applied to one or more output devices, in known fashion.

Each such computer program is preferably stored on or downloaded to a storage media or device, e.g., solid state memory or media, magnetic or optical media, etc., readable by a general or special purpose programmable computer, for configuring and operating the computer when the storage media or device is read by the computer system to perform the procedures described herein. The inventive system may also be considered to be implemented as a computer-readable storage medium, configured with a computer program, where the storage medium so configured causes a computer system to operate in a specific and predefined manner to perform the functions described herein. Software per se and intangible or transitory signals are excluded to the extent that they are unpatentable subject matter.

Aspects of the systems described herein may be implemented in an appropriate computer-based sound processing network environment for processing digital or digitized audio files. Portions of the adaptive audio system may include one or more networks that comprise any desired number of individual machines, including one or more routers (not shown) that serve to buffer and route the data transmitted among the computers. Such a network may be built on various different network protocols, and may be the Internet, a Wide Area Network (WAN), a Local Area Network (LAN), or any combination thereof.

One or more of the components, blocks, processes or other functional components may be implemented through a computer program that controls execution of a processor-based computing device of the system. It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical, non-transitory, non-volatile storage media in various forms, such as optical, magnetic or semiconductor storage media.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

1. A computer-implemented method of audio processing, the method comprising:
capturing, by an audio capturing device, an audio signal having at least two channels including a left channel and a right channel;
calculating, by a machine learning system, a plurality of noise reduction gains for each channel of the at least two channels;
calculating a plurality of shared noise reduction gains based on the plurality of noise reduction gains for each channel; and
generating a modified audio signal by applying the plurality of shared noise reduction gains to each channel of the at least two channels.

2. The method of claim 1, further comprising:
transforming the audio signal from a first signal domain to a second signal domain, wherein the first signal domain is a time domain, and wherein the plurality of noise reduction gains is calculated based on the audio signal having been transformed to the second signal domain; and
transforming the modified audio signal from the second signal domain to the first signal domain.

3. The method of claim 1, wherein calculating the plurality of noise reduction gains, calculating the plurality of shared noise reduction gains, and generating the modified audio signal are performed contemporaneously with capturing the audio signal.

4. The method of claim 1, further comprising:
storing the audio signal having been captured,
wherein calculating the plurality of noise reduction gains, calculating the shared noise reduction gains, and generating the modified audio signal are performed on the audio signal having been stored.

5. The method of claim 1, wherein calculating the plurality of noise reduction gains by the machine learning system comprises:
performing feature extraction on each channel of the at least two channels to generate a plurality of features for each channel;
processing the plurality of features for each channel, wherein processing the plurality of features for each channel comprises inputting the plurality of features for each channel into a machine learning model; and
outputting the plurality of noise reduction gains from the machine learning system as a result of inputting the plurality of features into the machine learning model.

6. The method of claim 5, wherein the machine learning model is a monaural model that has been trained offline using monaural audio training data;
wherein the plurality of features includes a first plurality of features corresponding to the left channel, and a second plurality of features corresponding to the right channel; and
wherein the plurality of noise reduction gains includes a first plurality of noise reduction gains corresponding to the first plurality of features, and a second plurality of noise reduction gains corresponding to the second plurality of features.

7. The method of claim 5, wherein the machine learning model is a binaural model that has been trained offline using binaural audio training data;
wherein the plurality of features is a joint plurality of features corresponding to both the left channel and the right channel; and
wherein the plurality of shared noise reduction gains results from the joint plurality of features corresponding to both the left channel and the right channel.

8. The method of claim 5, wherein the machine learning model includes a monaural model that has been trained offline using monaural audio training data and a binaural model that has been trained offline using binaural audio training data;
wherein the plurality of features includes a first plurality of features corresponding to the left channel, a second plurality of features corresponding to the right channel, and a joint plurality of features corresponding to both the left channel and the right channel; and
wherein the plurality of noise reduction gains includes a first plurality of noise reduction gains corresponding to the first plurality of features, a second plurality of noise reduction gains corresponding to the second plurality of features, and a joint plurality of noise reduction gains corresponding to joint plurality of features.

9. The method of claim 1 wherein the audio capture device comprises a first earbud that captures the left channel and a second earbud that captures the right channel;
wherein the plurality of noise reduction gains includes a first plurality of noise reduction gains and a second plurality of noise reduction gains; and
wherein calculating the plurality of shared noise reduction gains comprises combining the first plurality of noise reduction gains and the second plurality of noise reduction gains according to a mathematical function.

10. The method of claim 9, wherein the mathematical function includes one or more of an average, a maximum, a range function, and a comparison function.

11. The method of claim 9, wherein the first plurality of noise reduction gains corresponds to a first gain vector for a plurality of bands of the left channel, and the second plurality of noise reduction gains corresponds to a second gain vector for a plurality of bands of the right channel; and
wherein calculating the plurality of shared noise reduction gains comprises selecting, from the first gain vector and the second gain vector, a maximum gain for each band of the plurality of bands.

12. The method of claim 9, wherein the plurality of noise reduction gains further includes a joint plurality of noise reduction gains; and
wherein calculating the plurality of shared noise reduction gains comprises combining the first plurality of noise reduction gains, the second plurality of noise reduction gains and the joint plurality of noise reduction gains according to the mathematical function.

13. The method of claim 1, further comprising:
capturing, by a video capture device, a video signal contemporaneously with capturing the audio signal,
wherein the video capture device comprises a mobile telephone, wherein the mobile telephone includes a front camera and a rear camera.

14. The method of claim 13, further comprising:
switching from a first mode using one of the front camera and the rear camera, to a second mode using another of the front camera and the rear camera, wherein the switching includes smoothing a left/right correction of the audio signal using a first smoothing parameter, and smoothing a front/back correction of the audio signal using a second smoothing parameter.

15. The method of claim 13, wherein capturing the video signal contemporaneously with capturing the audio signal includes performing a correction on the audio signal, wherein the correction includes at least one of a left/right correction, a front/back correction, and a stereo image width control correction.

16. The method of claim 15, wherein performing the stereo image width control correction includes:
generating a middle channel and a side channel from a left channel and a right channel of the audio signal;
attenuating the side channel by a width adjustment factor; and
generating a modified audio signal from the middle channel and the side channel having been attenuated.

17. The method of claim 16, wherein the width adjustment factor is calculated based on a focal length of the video capture device.

18. The method of claim 16, wherein the width adjustment factor is updated in real time in response to the video capture device changing the focal length in real time.

19. A non-transitory computer readable medium storing a computer program that, when executed by a processor, controls an apparatus to execute processing including the method of claim 1.

20. An apparatus for audio processing, the apparatus comprising:
a processor, wherein the processor is configured to control the apparatus to execute processing including the method of claim 1.
